(19) United States
(12) Patent Application Publication
(10) Pub. No.: US 2005/0112914 A1
(43) Pub. Date: May 26, 2005

(54) Portable terminal for vehicle mounted computer

(75) Inventors: Hiroyasu Tanaka, Fuji-shi (JP); Toshiji Iida, Fuji-shi (JP); Miki Kinoshita, Fuji-shi (JP); Takashi Eguchi, Fuji-shi (JP)

Correspondence Address: FOLEY AND LARDNER;SUITE 500, 3000 K STREET NW, WASHINGTON, DC, 20007, US

(73) Assignee: JATCO Ltd

(21) Appl. No.: 10/970,720

(22) Filed: Oct. 22, 2004

(30) Foreign Application Priority Data
Oct. 24, 2003 (JP) 2003-364929

(51) Int. Cl. H01R 24/00

(52) U.S. Cl. 439/76.1

(57) ABSTRACT

A vehicle information collection device that is disposed in a compartment of a vehicle and collects vehicle information, comprising a cylindrical case (1), a connector (8) that is provided at one end of the case (1), for connection to the vehicle mounted computer (200), a main body (2) disposed inside the case (1), that transmits and receives a signal via the connector (8), and a lid (4) that closes the other end of the case (1). With this construction, the device can be easily disposed in the vehicle compartment.

### FIELD OF THE INVENTION

This invention relates to a portable terminal that performs communications with a vehicle mounted computer.

### BACKGROUND OF THE INVENTION

JP 10-55464 A issued in 1998 by Japan Patent Office discloses a device that records data indicating operating condition of a vehicle in an external storage medium.

### SUMMARY OF THE INVENTION

In use, the device is disposed near the driver's seat. However, no dedicated space for installing the device is provided. Therefore, the device takes up space near the driver's seat. When the device is provided on a dashboard, the device may move while the vehicle is running, and disturb the driving operation, or contact and damage the components near the device.

It is therefore an object of this invention to provide a portable terminal which does not take up space in a compartment of a vehicle, and which is firmly positioned even while the vehicle is running.

In order to achieve the above object, this invention provides a portable terminal that performs communications with a vehicle mounted computer, comprising; a cylindrical case; a connector that is provided at one end of the case, for connection to the vehicle mounted computer; a main body disposed inside the case, that transmits and receives a signal via the connector; and a lid that closes the other end of the case.

The details as well as other features and advantages of this invention are set forth in the remainder of the specification and are shown in the accompanying drawings.

### BRIEF DESCRIPTION OF THE DRAWINGS

FIG. 1 schematically shows a connection between a portable terminal according to an embodiment of this invention, which is received in a drink holder and a vehicle mounted computer.

FIGS. 2A and 2B are perspective views of the portable terminal according to an embodiment of this invention.

FIG. 3 is a perspective view of a main body of the portable terminal.

FIG. 4 is a plan view of the portable terminal as viewed from above.

FIG. 5 is a plan view of the portable terminal as viewed from beneath.

FIG. 6 is a cross sectional view of the portable terminal taken along the line VI-VI in FIG. 4.

FIG. 7 is a cross sectional view of the portable terminal taken along the line VII-VII in FIG. 4.

### DESCRIPTION OF THE PREFERRED EMBODIMENTS

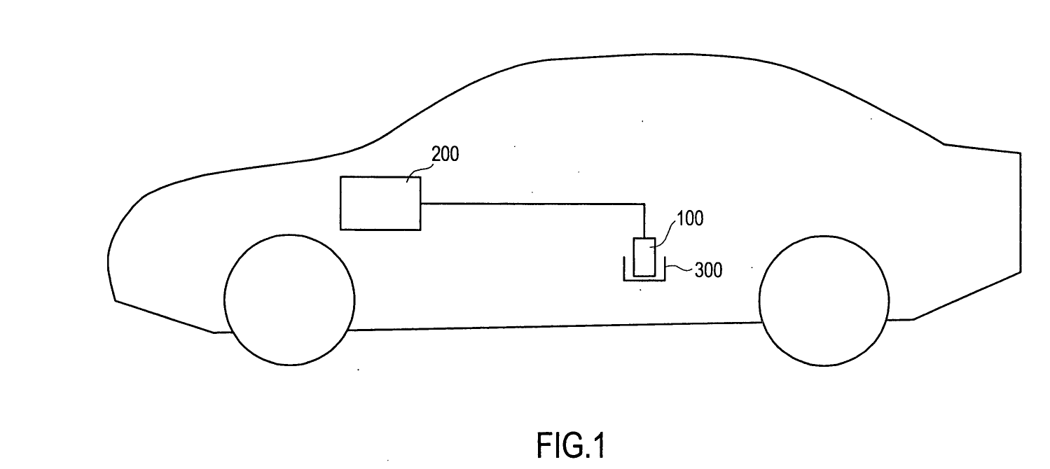

Referring to FIG. 1, a portable terminal 100 is a portable device that is connected with a vehicle mounted computer 200 and transmits various items of information such as running data through a serial bus system called “Controller Area Network (CAN)”.

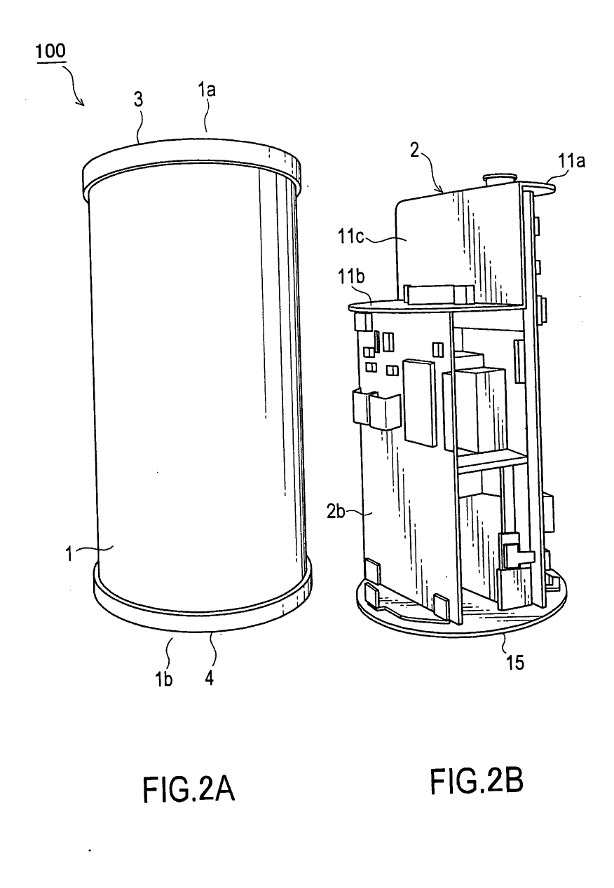

Referring to FIGS. 2A and 2B, the portable terminal includes a cylindrical case 1 and a main body 2 disposed inside the cylindrical case 1. A ring cap 3 is attached to an upper end 1a of the cylindrical case 1, and a bottom lid 4 is attached to a lower end 1b of the cylindrical case 1.

The outer diameter of the cylindrical case 1 is about 67 mm, which is substantially the same as the outer diameter of normal 350-milliliter beverage cans. The cylindrical case 1 is received by a drink holder installed in a compartment of the vehicle. The cylindrical case 1 is made of an aluminum thin plate. Therefore, the cylindrical case 1 is light, and held easily.

The ring cap 3 is made of rubber, and attached to an outer circumference of the upper end 1a of the cylindrical case 1. The ring cap 3 prevents an edge of the upper end 1a of the cylindrical case 1 from damaging other members in the compartment. Further, the temperature of the ring cap 3 made of rubber does riot increase in comparison with metal material. Therefore, even when the portable terminal is left in the vehicle, and heated to a high temperature, a person can hold and move the ring cap 3 easily.

The bottom lid 4 closes the lower end 1b of the cylindrical case 1. The bottom lid 4 is made of resin material. Therefore, the bottom lid 4 does not damage other members in the compartment of the vehicle. Heavy material with high density may be used for the bottom lid 4, so the portable terminal has the center of gravity at a low position, and the portable terminal is firmly placed in the compartment of the vehicle.

The main body 2 comprises a main board 2a and a sub-board 2b. There are provided a central processing unit (CPU), a memory, and a power unit on those boards. The main board 2a and the sub-board 2b are provided in parallel with each other, and vertically upright on a circular lower panel 15. The vertical length of the main board 2a is longer than that of the sub-board 2b. The vertical length of the main board 2a and the vertical length of the sub-board 2b depend on the layout of electronic components of the main body 2. As the main board 2a and the sub-board, 2b get shorter, the position of the center of gravity of the portable terminal becomes lower. Such portable terminal does not tilt down easily, and is firmly positioned. An upper panel 11 is fixed to an upper end of the main board 2a and an upper end of the sub-board 2b.

The upper panel 11 includes an upper semicircular surface 11a fixed to the main board 2a, and a lower semi-circular surface 11b fixed to the sub-board 2b. The upper end of the main board 2a is higher than that of the sub-board 2b. Therefore, there is a step between the upper semicircular surface 11a and the lower semicircular surface i lb. The upper semicircular surface 11a and the lower semicircular surface 11b are connected by a coupling surface 11c.

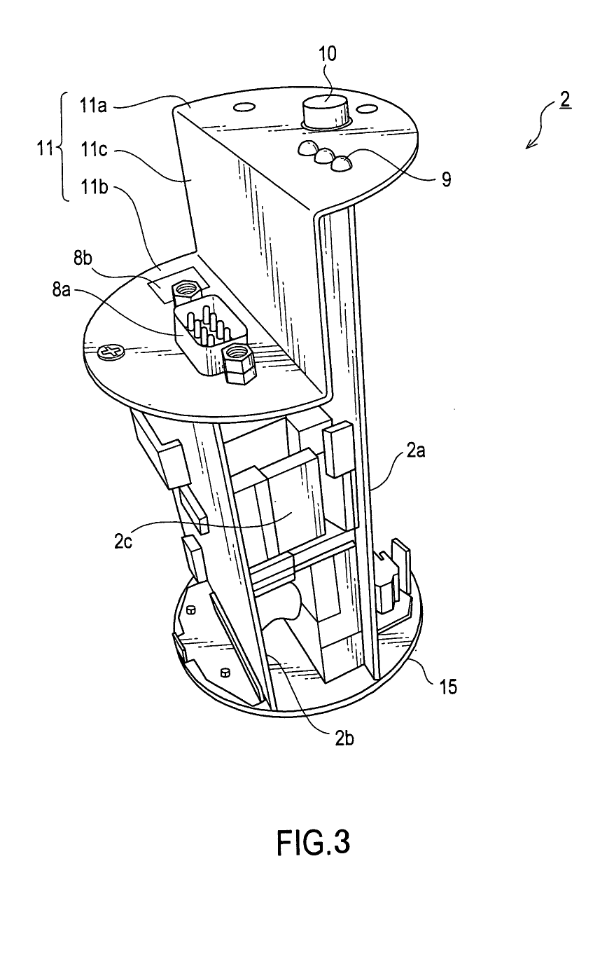

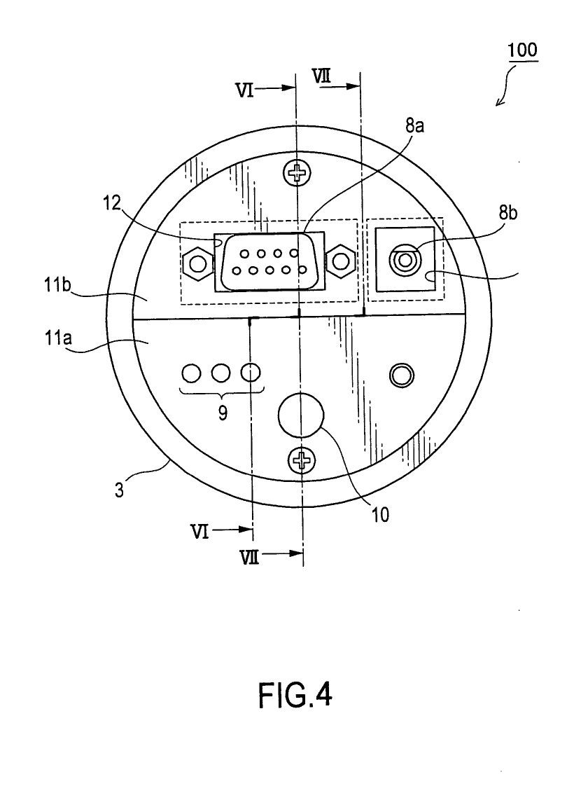

With reference to FIGS. 3 and 4, the main body 2 will be described further in detail.

The main board 2a and the sub-board 2b are interconnected by a connector board 2c to form an electric circuit and a signal circuit.

LEDs 9 indicating the operating condition of the portable terminal are arranged on the upper semicircular surface 11a of the upper panel 11. The LEDs 9 have different colors, and the number of LEDs 9 is three. The LEDs 9 reports the operating condition to a driver or a user of the portable terminal. Preferably, the relationship between lighting patterns of the LEDs 9 and the operating condition of the portable terminal be marked on the outer circumferential surface of the cylindrical case 1.

A push switch 10 is provided on the upper semicircular surface 11a. The push switch 10 is manipulated by the driver or the user of the portable terminal. When the push switch 10 is pressed, the main body 2 starts recording signal information inputted from the CAN of the vehicle.

A connector 8a for connection to the CAN of the vehicle is provided on the lower semicircular surface 11b of the upper panel 11. The signal from CAN of the vehicle is inputted into the main body 2 via the connector 8a. Further, a terminal 8b that obtains electricity from a cigar lighter socket of the vehicle is provided on the lower semicircular surface 11b.

It is preferable to provide the connector 8a and the terminal 8b on the lower semicircular surface 11b for the following reasons.

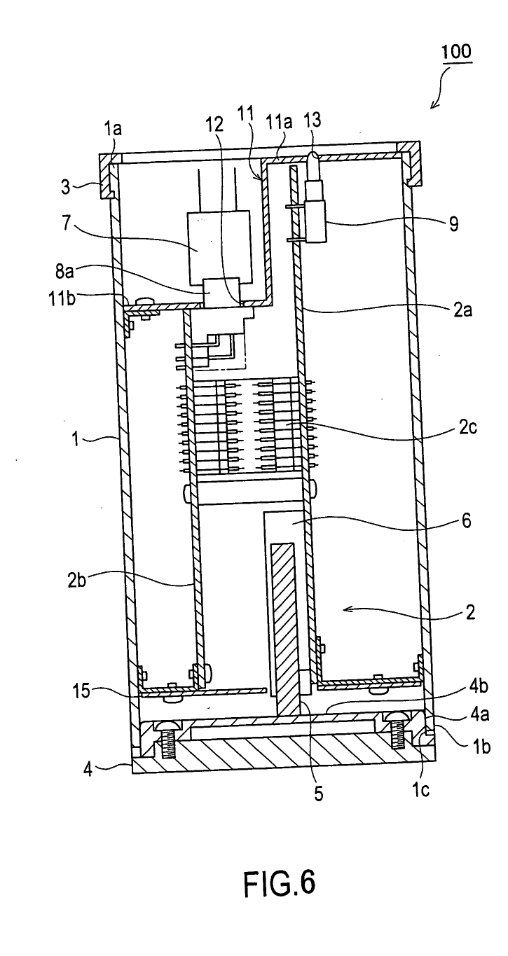

Referring to FIG. 6, a connector 7 of a cable connected to the connector 8a and a terminal of a power source cable that supplies electricity to the terminal 8b are both provided in a recess surrounded by the lower semicircular surface 11b, the coupling surface 11c, and the inner circumferential surface of the cylindrical case 1, and do not protrude from the cylindrical case 1 upwardly. Therefore, when the portable terminal is used, it is possible to keep the height of the portable terminal substantially at a low level. Further, the structure is helpful to protect the connector 7 and the terminal of the power source cable.

The length of the cylindrical case 1 is determined such that the LEDs 9, the push switch 10, and the connector 7 of the cable connected to the connector 8a do not protrude from the cylindrical case 1. With the structure which prevents protrusion of components from the cylindrical case 1, even when the portable terminal tilts down, other members around the portable terminal, or in-vehicle components are not damaged.

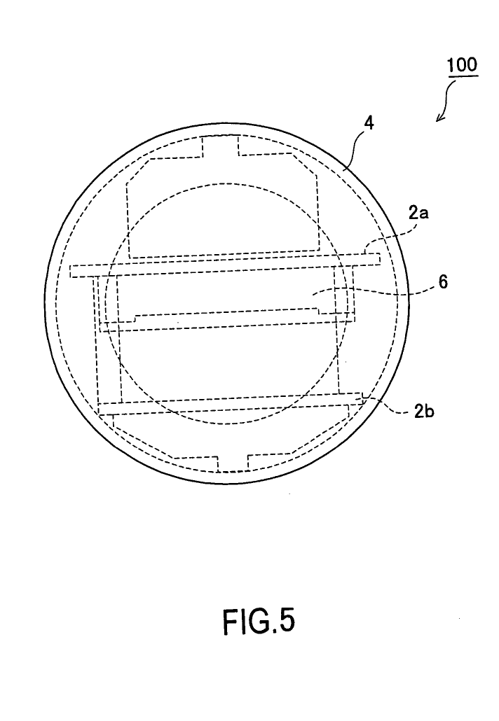

Referring to FIG. 5, the main body 2 includes a slot 6 for inserting a memory card 5 as a detachable storage medium between the main board 2a and the sub-board 2b. The slot 6 has a connector for connection to the memory card 5.

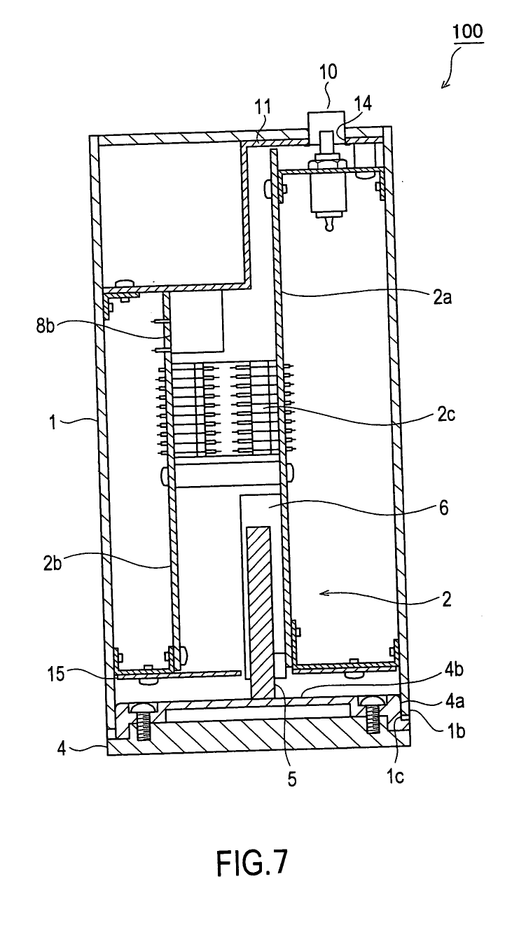

Referring to FIGS. 6 and 7, the upper panel 11 and the lower panel 15 are fixed to the cylindrical case 1, respectively. The main board 2a and the sub-board 2b are fixed to the cylindrical case 1 through the panels 11, 15. Even when the cylindrical case 1 is heated to a high temperature, the heat of the cylindrical case 1 is not transmitted to the two boards 2a, 2b significantly. Thus, the thermal affect to the electronic components attached to the boards 2a, 2b is suppressed. Further, since the cylindrical case 1 is hermetically closed by the panels 11, 15, it is possible to prevent the entry of dust into the cylindrical case 1.

A female screw 1c is formed in an internal circumferential surface at the lower end of the cylindrical case 1. The bottom lid 4 has a male screw 4a screwed into the female screw 1c. The male screw 4a has a chamfered tip end, so the bottom lid 4 is easily attached to the cylindrical case 1.

In order to reduce the overall height of the portable terminal, the length of the female screw 1c and the length of the male screw 4a are minimized in so far as the required tightening force by the screws 1c, 4a is maintained.

Rubber material is attached to a surface 4b of the bottom lid 4 which contacts the memory card 5. After the memory card 5 is inserted into the slot 6, the bottom lid 4 is screwed into the cylindrical case 1. The bottom lid 4 screwed into the cylindrical case 1 keeps the memory card 5 inside the slot 6 by the elastic force of the rubber member. This prevents disconnection of the memory card 5 from the connector in the slot 6 due to vibrations while the vehicle is running.

Since the slot 6 is closed by the bottom lid 4 hermitically, it is possible to prevent the entry of dust into the slot 6. The structure of the bottom lid 4 is helpful to prevent contact failure of the memory card 5 and the connector in the slot 6. Further, the slot 6 is provided at a substantially central position in the cylindrical case 1. Therefore, the heat from the cylindrical case 1 is not transmitted to the slot 6 significantly. The desired environment for preventing malfunction of the memory card 5 due to the heat is achieved.

The upper semicircular surface 11a of the upper panel 11 has a hole 13 and a hole 14. The LEDs 9 protrude upward through the hole 13. The push switch 10 passes through the hole 14. The lower semicircular surface 11b of the upper panel 11 has a hole 12 and a hole 16. The connector 8a passes through the hole 12, and the terminal 8b passes through the hole 16.

The main body 2 receives the signal from the CAN installed in the vehicle, and records the necessary data in the memory card 5.

The portable terminal having the structure as described above can be set in a drink holder equipped in the compartment of the vehicle. Therefore, the portable terminal does not take up space in the vehicle. Further, the vehicle is firmly held even while the vehicle is running.

The portable terminal according to the above embodiment of the present invention is described as a terminal that collects the vehicle information. However, the present invention is not limited to the embodiment described above, the communications may be achieved between the CPU provided in the main body 2 and the vehicle mounted computer 200.

The contents of Tokugan 2003-364929 with a filling date of Oct. 24, 2003 in Japan are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

The embodiments of this invention in which an exclusive property or privilege is claimed are defined as follows:

1. A portable terminal that performs communications with a vehicle mounted computer, comprising:
a cylindrical case;
a connector that is provided at one end of the case, for connection to the vehicle mounted computer;
a main body disposed inside the case, that transmits and receives a signal via the connector; and
a lid that closes the other end of the case.

2. The portable terminal as defined in claim 1, wherein the device further comprises a panel that fixes one end of the main body to the case and on which the connector is provided.

3. The portable terminal as defined in claim 1, wherein the diameter of the case is 67 mm or less.

4. The portable terminal as defined in claim 1, wherein the case is made of aluminum.

5. The portable terminal as defined in claim 1, wherein the device further comprises a ring cap that is attached to one end of the case and covers an edge of the case.

6. The portable terminal as defined in claim 1, wherein the connector is disposed in the case and does not protrude from one end of the case.

7. The vehicle information collection as defined in claim 2,
wherein the panel includes two semicircular surfaces which are offset in the direction of the central axis of the case, and
wherein the connector is formed on one semicircular surface of the two semicircular surfaces which is disposed in the case.

8. The portable terminal as defined in claim 7, wherein the body main includes two boards provided in parallel with each other along the direction of the central axis of the case, an end of one board is fixed to one semicircular surface of the two semicircular surfaces, and an end of the other board is fixed to the other semicircular surface of the two semicircular surfaces.

9. The portable terminal as defined in claim 8, wherein the device further comprises a slot provided between the two boards, and a detachable storage medium inserted into the slot.

10. The portable terminal as defined in claim 1,
wherein the lid is screwed into the case so as to be freely detached from the case, and
the device further comprises a detachable storage medium that is inserted into the main body with the lid removed from the case.

11. The portable terminal as defined in claim 9, wherein the device further comprises a switch that is provided on one semicircular surface of the two semicircular surfaces exposed externally in the direction of the central axis of the case and issues an instruction to start storing information in the detachable storage medium.

12. The portable terminal as defined in claim 1, wherein the lid is made of resin.

13. The portable terminal as defined in claim 7, wherein the device further comprises an indicating part that is provided on one of the semicircular surfaces exposed externally in the direction of the central axis of the case and indicates a operation condition of the main body.

14. The portable terminal as defined in claim 7, wherein the device further comprises a switch that is provided on one semicircular surface of the two semicircular surfaces exposed externally in the direction of the central axis of the case and issues an instruction to start operation of the main body.
